(19) United States
(12) Patent Application Publication
(10) Pub. No.: US 2017/0330443 A1
(43) Pub. Date: Nov. 16, 2017

(54) SYSTEM FOR TRACKING LOCATION OF A PERSON

(71) Applicant: Anthony M. Helferich, Mobile, AL (US)

(72) Inventor: Anthony M. Helferich, Mobile, AL (US)

(21) Appl. No.: 15/155,482

(22) Filed: May 16, 2016

(51) Int. Cl. G08B 25/01; G08B 25/10; H04W 4/02

(52) U.S. Cl. CPC G08B 25/016; G08B 25/10; H04W 4/02

(57) ABSTRACT

A system and a method for tracking the location of a person are provided. The system includes means for wearable housing, means for data communication, means for data interface and a means adapted for a computing device. The means for wearable housing includes a battery, an antenna, a heart monitoring sensor, a distress signal actuated button and a global positioning system (GPS) microchip and the means for communication is configured to receive the distress signal and location of a sender by the GPS microchip. Further, the means for data interface is configured to have a sender identification form for identifying the sender and the computing device is configured to monitor the sender by the means for communication.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to the field of a system for tracking location of a person and method thereof. The invention, particularly relates to a system for tracking location of a person and method thereof, which enables a monitoring agency to track an individual and allows the individual to be located while receiving a distress signal by the monitoring agency.

### 2. Description of Related Art Including Information Disclosed Under 37 CFR 1.97 and 37 CFR 1.98.

A central monitoring facility is known to the technology for monitoring an individual with the help of a Global Positioning System and the like devices at a plurality of remote locations. For example, it is common for police personnel to locate the individual after getting an alert or message while the individual is in danger or advise other appropriate authorities upon receiving the message. It is also known to provide communication means enabling a central monitoring facility to query a location monitoring system at a remote location to determine the location status of the individual. In conventional location monitoring method, a broadcast system for enabling monitoring agency to monitor only the kind of information of interest to the person. For example person location, which allow the monitoring agency to program a digital code into a receiver so that the receiver triggers only in response to specific digital codes broadcast on the monitored radio channels. Thereafter, a human interface device is provided, allowing an individual or occupant to signal the monitoring agency that a particular type of assistance is needed for the located individual.

There have been a number of solutions provided for efficient and dynamic location tracking of the individual and few of them have been discussed below:

U.S. Pat. No. 5,742,233 A discloses a signaling system which comprises a portable signaling unit, a remote alarm switch device, a central dispatch station and a wireless communication system such as a cellular or telephone system etc., and a GPS or alike system. The portable signaling unit and the remote alarm switch may be adapted to be worn at different locations on the person's body. The remote alarm switch may be concealed in the form of a wristband or in the form of any other object such as a broach, pendant, or keychain. When the person in distress activates the remote alarm switch or when the remote alarm switch is removed from the individual by a forceful or unauthorized action or when the signaling unit is removed from the proximity of the remote alarm switch, the portable signaling unit sends a data transmission which includes its location to the central dispatch station.

U.S. Pat. No. 5,852,401 A describes a distress message sending device worn by the user, a positional information generator receives GPS signals sent by a plurality of GPS satellites and generates positional information on the latitude and longitude of the position of the user. When the user meets a disaster, a distress message signal generator generates a distress message signal containing the positional information generated by the positional information generator. Further, a sender then sends out the distress message signal by radio.

WO 2015019360 A1 relates to a wearable, multi-sensory, personal safety and tracking device which predicts danger by sensing changes in voice, pulse, emotions, impact, motion of the wearer and the device state. In emergency situations, the device triggers SOS, alarm, electro shock, pepper spray and starts capturing images and audio recording for the safety of the wearer. For keeping a track of the wearer, the device connects to the internet using GPRS and sends the images clicked, the sound recorded and the GPS and GSM coordinates to the rescue team for gaining help for the wearer if needed.

The aforesaid documents and other similar solutions may strive to provide efficient and dynamic location monitoring system; however, they still have a number of limitations and shortcomings such as, but not limited to, inability to provide a heart rate monitoring with a pin-point locating technology and further, enables the monitoring agency to locate the individual by a tiny sensors having a means of an automated actuating the device. The above mentioned prior arts can only perform certain aspects say for example provides a location monitoring system by a means of satellite communication with GPS device or a like system.

Accordingly, there remains a need in the prior art to have an improved system and method thereof, for efficient location monitoring system which also enables the agency to control the system while the individual could not use the wearable GPS device, therefore overcome the aforesaid problem and shortcomings.

### BRIEF SUMMARY OF THE INVENTION

In the view of the foregoing disadvantages inherent in the known types of a system for tracking location of a person now present in the prior art, the present invention provides an improved a system for tracking location of a person and method thereof. As such, the general purpose of the present invention, which will be described subsequently in greater detail, is to provide a new and improved a system for tracking location of a person and method thereof, for tracking the movement of an individual, which has all the advantages of the prior art and none of the disadvantages.

An object of the invention is to provide a system for tracking location of a person which comprises a means for wearable housing, means for data communication, means for data interface and a means adapted for a computing device.

It is another object of the present invention to provide a method for tracking location of a person, comprising the steps of wearing a position monitoring wearable device having a distress signal actuated button and a heart monitoring sensor by a user; initiating the position monitoring device with a login credential; receiving periodically a prioritized signal data by a communication network; receiving the prioritized signal data from the communication network on a computing device; monitoring the prioritized signal data on the computing device and determining location of the prioritized signal data after using a distress signal actuated button and a heart monitoring sensor in danger time for the user on the computing device.

It is another object of the present invention to provide the system is configured, but not limited to, trigger a call or messaging service after receiving the distress signal or no pulse rate of heart for the user.

It is another object of the present invention to provide the system is having a wearable item which is further made from, but not limited to, a durable metal, plastic, fabric or the like.

It is another object of the present invention to provide the system allows authorized users to log in to a computer or any other computing device and track the GPS location of the individual while it needed.

It is another object of the present invention to provide the wearable item is, but not limited to a ring. Preferably, the wearable item is weatherproof, sturdy and easy to wear.

It is another object of the present invention to provide the system can also be used, but not limited to, by corporations for desiring the safety of employees and contractors travelling to hostile environments or volatile colonial areas.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of a system for tracking location of a person in accordance with an embodiment of the present invention.

FIG. 2 illustrates a side view of the system for tracking location of a person as shown in FIG. 1.

FIG. 3 illustrates a front view of the system for tracking location of a person as shown in FIG. 1.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention generally provides a system for tracking location of a person. The system comprises means for wearable housing, means for data communication, means for data interface and a means adapted for a computing device. The means for wearable housing includes a battery (8), an antenna (14), a heart monitoring sensor, a distress signal actuated button (5) and a global positioning system (GPS) microchip (11) and the means for communication is configured to receive the distress signal and location of a sender by the GPS microchip (11). Further, the means for data interface is configured to have a sender identification form for identifying the sender and the computing device is configured to monitor the sender by the means for communication.

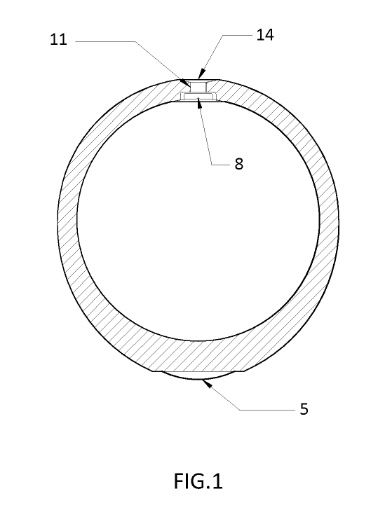

As shown in FIG. 1, a system for tracking location of a person and method thereof, comprising the steps of wearing a position monitoring wearable device having a distress signal actuated button (5) and a heart monitoring sensor by a user; initiating the position monitoring device with a login credential; receiving periodically a prioritized signal data by a communication network; receiving the prioritized signal data from the communication network on a computing device; monitoring the prioritized signal data on the computing device and determining location of the prioritized signal data after using a distress signal actuated button and a heart monitoring sensor in danger time for the user on the computing device.

In accordance with an embodiment of the present invention, the position monitoring wearable device further comprises a battery (8), an antenna (14) and a global positioning system (GPS) microchip (14). Preferably, the position monitoring wearable device is, but not limited to, a jewelry. The jewelry is a ring or the like any wearable structure which is weather proof, sturdy and easy to wear.

The system is to provide personal safety and security for all ages or persons by wearing it. Further, the system is also to be designed in a manner such that every age of person can wear it. Another, use of the present invention, is not only limited to, personal use; it can also be used for commercial purpose like the Corporations could also use the invention to track employee location and ensure safety, either supplying their employees with the wearable ring during working hours or allowing the employees to lock their employer out of viewing when on personal time.

The system is also having the antenna (14) which configured to send an amplified distress signal to the data communication network and heart monitoring sensor used for detecting a pulse rate of heart that produces distress signal while in abrupt condition like sudden unconsciousness, heart-attack or other related physical condition for the person. Further, the person can also produce distress signal while in danger by the distress signal actuated button (5) installed on the wearable device.

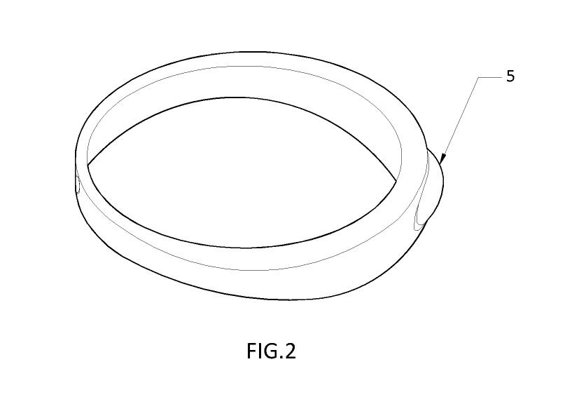

FIG. 2 is the side view of the system for tracking location of a person of FIG. 1. The present invention provides a very efficient and dynamic system and method for location tracking of a person. The system is configured to provide an antenna (14) in a wearable device which coiled in the housing of the wearable device. Further, the antenna (14) is to be used for amplifying the data signal or distress signal that is actuated by a distress signal button (5) installed on the wearable device and sends the actuated distress signal to the data communication network. The system is having a computing device which emplaces at monitoring center or agency and configured to connect with the data communication network.

In accordance with an embodiment of the present invention, the monitoring agency has a database for storing the login credential of the person. The monitoring agency locates the person and can also track the person with the help of GPS device (11) which is installed in the housing of the wearable device. Further, the monitoring agency communicates with the user while a distress signal is triggered on the computing device by a cell-phone, password or user login credential.

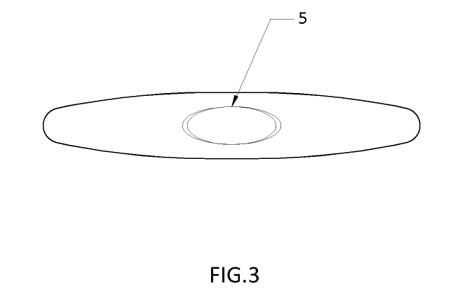

FIG. 3 is the front view of the system for tracking location of a person of FIG. 1. The present invention is configured to provide a weatherproof wearable device having a distress signal actuating button (5). The button (5) can be pressed easily and further, connected to the antenna (14) for sending the distressed signal to the monitoring center or agency.

In accordance with an embodiment of the present invention, the wearable housing is configured to have a power supply unit for supplying power to the other unit of the wearable housing. Preferably, the power supply unit (8) consists of a replaceable battery. A solid tone is emitted whenever there is need to replace the depleted battery.

The above-mentioned a system for tracking location of a person provides a flexible way to track the individual by an easy wearable device. The system provides, but not limited to, a ring shape device which has a button for pressing at the time of disaster for sending signals to the monitoring agency. In addition, it allows authorized users to log in to a computer and track the GPS location of the user. It is helpful in tracing the wearer in less span of time. It eliminates the old process of tracing someone. These unique features may make it non-obvious for a person skilled in the art to derive upon the current invention.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. A system for tracking location of a person, comprising:
means for wearable housing;
means for data communication;
means for data interface;
means adapted for a computing device;
wherein said means for wearable housing includes a battery, an antenna, a heart monitoring sensor, a distress signal actuated button and a global positioning system (GPS) microchip;
wherein said means for data communication is configured to receive said distress signal and location of a sender by said GPS microchip;
wherein said means for data interface is configured to have a sender identification form for identifying said sender; and
wherein said computing device is configured to monitor said sender by said means for communication.

2. The system according to claim 1, wherein said means for wearable housing is a jewelry.

3. The system according to claim 2, wherein the said jewelry is selected from a group consisting of: a ring, a hand band and a bracelet.

4. The system according to claim 1, wherein said antenna is configured to send an amplified distress signal to said means for communication.

5. The system according to claim 1, wherein said heart monitoring sensor is used for detecting a pulse rate of the heart.

6. The system according to claim 1, wherein said distress signal actuated button is activated in a dangerous time by said sender.

7. The system according to claim 1, wherein said battery is configured to provide power supply to said means for wearable housing.

8. The system according to claim 1, wherein said sender identification form is configured to store said sender login credentials on said computing device.

9. The system according to claim 1, wherein said computing device is configured to store said sender profile information.

10. The system according to claim 1, wherein said computing device is located at a monitoring center.

11. The system according to claim 1, wherein said distress signal is further actuated by a predetermined value of said pulse rate of the heart.

12. A method for tracking location of a person, comprising steps of:
providing a position monitoring wearable device including a distress signal actuated button and a heart monitoring sensor for a user;
initiating said position monitoring device with login credential;
receiving periodically a prioritized signal data by a communication network;
receiving said prioritized signal data from said communication network on a computing device;
monitoring said prioritized signal data on said computing device; and
determining location of said prioritized signal data after using said distress signal actuated button and said heart monitoring sensor in danger time for said user on said computing device.

13. The method according to claim 12, wherein said position monitoring wearable device further comprises a battery, an antenna and a global positioning system (GPS) microchip.

14. The method according to claim 12, wherein said position monitoring wearable device is a jewelry.

15. The method according to claim 14, wherein said jewelry is selected from a group consisting of a ring, a hand band and a bracelet.

16. The method according to claim 12, wherein said prioritized signal data is further actuated said communication network by a predetermined value of said pulse rate of heart.

17. The method according to claim 12, wherein said computing device is located at a monitoring center.

18. The method according to claim 12, wherein said computing device is configured to connect to said communication network.
